(19) United States
(12) Patent Application Publication
(10) Pub. No.: US 2003/0105831 A1
(43) Pub. Date: Jun. 5, 2003

(54) Peer-to-peer (P2P) and internet content delivery based user based digital acknowledgement trigger used for file transfer

(76) Inventor: Robert O'Kane, Palm Beach Gardens, FL (US)

Correspondence Address: JEFFREY FURR, 253 N. MAIN STREET, JOHNSTOWN, OH, 43031, US

(21) Appl. No.: 09/683,228

(22) Filed: Dec. 4, 2001

(51) Int. Cl. G06F 15/16

(52) U.S. Cl. 709/217

(57) ABSTRACT

A system and method is disclosed for information sharing via a peer-to-peer communication network. The system provides for a way to track DIGITAL MEDIA files (a.k.a. video, audio and yet to be determined digital source) over global and through, or hosted on, a local or remote network server. Each User has a unique digital software trigger, or “digital acknowledgement trigger” which is software originated. Each tag is unique based upon the User, and with each user the trigger” or “digital acknowledgement trigger” is activated at the time the Digital File is used or opened without damaging the original file from which the download file was “shared.”

### BACKGROUND OF INVENTION

1. Field of the Invention

This invention relates to the art of transferring data files between users and more specifically, to the use of peer to peer processing for this purpose of delivery of royalties for intellectually protected materials and/or files.

2. Description of Prior Art

In conventional systems and methods for sharing information, an originator of the information will typically provide the information through an electronic site such as a web site. Users wishing to obtain the information must have available to them, or must download, specific software to their computers or other devices that allow them to access and otherwise use, store, play, or display the information. Representative examples of information typically shared in this manner include, among other things, text, graphical images, sound files, and the like. Once information is obtained by a user, the originator has little (if any) ability to control what the user does with the information. For example, the user subsequently may, in violation of the wishes of the originator, copy the information or disseminate it such that the originator is no longer able to control by whom and when the shared information can be listened to, read, or seen.

A strong need has developed to find a way to track files that are exchanged and used by parties over the Internet and computer regulated networks, websites and exchanges that encourage downloading and exchanging of files that are intellectually protected. Currently, there does not exist a device or process available that reads, tracks and pays royalties using a new technology in the advertising world for the “proper use” of files that flow directly from one computer/user to another, unseen and untouched by any person or company.

These networked technologies, P2P networking, or file sharing networks, allow individual computer users to open their computer related hard drives directly to one another, searching for and swapping files without recourse to more traditional Web databases and servers. Again, there is no method or process available that determines and tracks such file transfers while paying royalties for “proper use” In recent years, companies that managed these types of networks, P2P networking, or file sharing networks, allowed people to share music files, video files and just about any other file with no regulatory control. P2P networks, by definition, do not have such technologies or “process” that helps those who own multi-media intellectual rights to track, sell and determine who shares and uses digital media files (a.k.a video, audio, digital art yet to be determined digital source) and that potential loss of control and security has made it more difficult for entrepreneurs and businesses to devise obvious business models that curb the copyright and security fears.

P2P AUDIO AND VIDEO networks work as follows: • A user/computer “user” asks a “computer or network related computer or server” if a audioart file exits on that particular computer or network related computer or server. • Every computer or network server or device which is “hooked” up or hooked into that same particular computer or network related computer or server mentioned in above, responds with a YES or a NO. • Every computer or network server or device which is “hooked” up or hooked into that same particular computer or network related computer or server mentioned in above that answers yes, then hooks up or hooks directly into the user/computer's computer or network related computer or server for download. • Or the user receives the file in or through an email message. • Or the user transfers the file on a portable memory card (as used in portable MP3 players) • Or the user uses a wireless enabled device (cellular phone, Personal Digital Assistant etc) • Or the user shares/copies/uploads/modifies the file through any means of electronic communication device(s)

Esther Dyson, chair woman of the Internet Corporation for Assigned Names and Numbers, wrote in a column in October, 2000. “Peer-to-peer communities need a way to define and identify their members. They need a way to define their own rules and to exclude people who break them. “Business interests already are trying to find answers that will allow for widespread legal P2P commercialization. For example of how P2P networks have had no control, NAPSTER, Aimster, BearShare, Gnutella and more that all have ended up with legal, P2P, related suits and the industry has yet to develop a way to track the exchange and or download and illegal use of intellectual properties. (songs, video's, software) NAPSTER (www.napster.com) Aimster.com and BearShare.com provides the most illuminating illustration of P2P or file sharing business models/infrastructure. Record companies are seeing their music distributed at unprecedented speeds, but they've lost control of the ability to guide and profit from the system.

Any company that hopes to commercialize and stop losing potential business related revenues from peer-to-peer networks must figure out a way to relinquish the right amount of control to its customers without giving away the profitable “commercialization” possibilities.

There is a lot of hard evidence that shows people use P2P type networks and “shared file” networks only because they do not have to pay for all the material they download. Naturally, entities that own respective files, that are “shared” will not take millions of people to court. They will however, shut down the entities that supply a way that files can be exchanged “for free”.

Business and corporate leaders are trying to come up with ways to keep all parties involved within a P2P platform chain are happy, legal and working. They are even trying to arrange for “paid” subscription business models. Most of all, P2P networks offer little regulation or protection of rightful properties inside anonymous networks, which was once a barrier to creating mainstream, integrated business processes.

U.S. Pat. No. 6,183,366 by Goldberg, et al. and issued on Feb. 6, 2001 is for “Network gaming system.” It discloses an information service and advertising providing system for presenting interactive information services together with interactive advertising on a communications network such as the Internet and LANs.

U.S. Pat. No. 6,029,200 by Beckerman, et al. and issued on Feb. 22, 2000 is for an “Automatic protocol rollover in streaming multimedia data delivery system.” It discloses a streaming multimedia rendering system having a network client and a network server that form part of a hyperlink web such as the Internet. In accordance with the invention, a hyperlink to multimedia content is actually an indirect link to a reference file. The reference file contains a plurality of different resource specifiers and a preferred order for attempting communications using the resource specifiers.

U.S. Pat. No. 6,248,946 by Dwek and issued on Jun. 19, 2001 is for a “Multimedia content delivery system and method.” It discloses a system and method for delivering multimedia content to computers over a computer network, such as the Internet includes a novel media player which may be downloaded onto a user's personal computer. The media player includes a user interface which allows a listener to search an online database of media selections and build a custom playlist of exactly the music selections desired by the listener. The multimedia content delivery system delivers advertisements which remain visible on a user's computer display screen at all times when the application is open, for example, while music selections are being delivered to the user. The advertisements are displayed in a window which always remains on a topmost level of windows on the user's computer display screen, even if the user is executing one or more other programs with the computer.

United States Patent Application 20010037367 by lyer is a “System and method for sharing information via a virtual shared area in a communication network.” It discloses a system and method is disclosed for information sharing via a virtual shared area in a communication network. The system includes a virtual shared area having a unique electronic identifier, the shared area being controlled by an owner for permitting access to information in the shared area by multiple users.

United States Patent Application 20010037304 by Paiz is for a “Method of and apparatus for delivery of proprietary audio and visual works to purchaser electronic devices.” The method preferably includes the additional steps of encrypting the works; and provides the end user with program means for deciphering the works. This method preferably includes the additional steps of delivering advertising matter to the end user with each work the end user selects and plays; keeping a record of the particular works each end user selects and plays; customizing advertising delivered to the end user to fit within any pattern of work selection by the particular end user.

There needs a way to transfer files using a digital acknowledgement trigger that conforms to and does not violate the Digital Millennium Act of 1998.

The need for a method for peer-to-peer file transfers that is secure, quick, profitable, and legal to use shows that there is still room for improvement within the art.

### SUMMARY OF INVENTION

The object of the present invention is to provide a process that allows intellectual property owners a well defined method to retain, track and possibly pay royalties for their properties through P2P (“peer to peer”) or shared file networks that resemble the likes of, for example: NAPSTER, MP3.com, and/or other similar computer file sharing computer networks. It also provides for a method to enforce Digital Millennium Act of 1998.

The current invention the process uses a user digital acknowledgement trigger that when created by software that make digital acknowledgement trigger to work and activate uniquely for each User, creates and defines that process which is needed to regulate the current infrastructure of P2P or file sharing networks, infrastructures or computer systems and computer networks overall, where individuals that are sharing information and content directly, can now be tracked and each file they use can be accounted for royalty payment by way of computer programs work coincide to regulate and track the actual users. It is a self running application that is also updated by a “individual” user who updates the software, which includes logic that make digital acknowledgement trigger “work and activate”, for centralized development, uniformity and would guarantee the integrity of those same files that are stored and shared on the above mentioned servers and networks.

The user digital acknowledgement trigger solves the following problems that currently exist with P2P and file sharing networks: • Entities are Unable to track file downloads • Entities are Unable to protect intellectual downloads and usage. • Entities are Unable to determine the amount of downloads and or time the file has been “shared” • Entities are Unable to commercialize, profit due to the illegal bootlegging and “use” of their properties. P2P networks and file sharing networks are one of the best way for businesses or corporations to conserve resources in the way of business development and operational costs. In reality, the people, or the consumer loves the “file swapping process” because it's free and communicable between people, colleagues and associates. In short, file-swapping networks are rewriting the content distribution revolution for business and network, computer related file transfers. There is nothing in place to regulate or track it.

The current invention will allow a person to receive a file from another source and creates a royalty generating process that allows the person “proper use of the file or content.” If a person sends a file the recipient will also be allowed “proper use” of the file for the technology would have produced a royalty for this as well. In retrospect, the other P2P based businesses do not provide tracking and royalty distribution for their users “proper use.” In summary, the user digital acknowledgement trigger enabled process, creates a method for justify these subsidizations.

The current invention is geared and works with, and is not limited to any of the below file sharing industries: • Audio Multi-Media File Sharing • Video Multi-Media File Sharing • Digital Audio File Sharing • Digital Video File Sharing • Gaming Software • Digital Images • Computer Software • Digital Coupons.

The process is more efficient, effective, accurate and functional than the current art.

### BRIEF DESCRIPTION OF DRAWINGS

Without restricting the full scope of this invention, the preferred form of this invention is illustrated in the following drawings:

FIG. 1 shows an overview of how a User accesses the system through the Internet.

FIG. 2 shows an overview of peer-to-peer processing.

FIG. 3 shows diagram illustrative a representative user computer system that is connected to the network.

FIG. 4 shows a diagram representing agents that may be stored on the client computer systems to enable those systems to utilize and contribute to the network in accordance with the invention.

FIG. 5 shows the process on the current invention.

FIG. 6 shows how the digital acknowledgement trigger is attached to a user.

FIG. 7 shows how a file is transferred to a requesting User.

FIG. 8 shows the obtaining a file.

FIG. 9 shows a diagram on exchanging a file in a P2P setting for an other User's use.

### DETAILED DESCRIPTION

The current invention process, the user digital acknowledgement trigger, when created by software that make digital acknowledgement trigger work and activate, creates and defines that process which is needed to regulate the current infrastructure of P2P or file sharing networks, infrastructures or computer systems and computer networks overall, where individuals that are sharing information and content directly, can now be tracked and used by way of computer programs that work coincide to regulate, track the actual users file use and royalty payment. The user digital acknowledgement trigger allows the user to select their choice of their audio or video advertisement which acts as their payment for “proper use.” The file is then downloaded to a pre determined area on the user”s hard drive for their “proper use”. The user digital acknowledgement trigger also prevents the file from leaving this secure area on the user”s hard drive without first acknowledging that the receipt also has a unique digital acknowledgement trigger to receive, track, determine ad and file download for “proper use.” This again is based on the user”s preferences which the digital acknowledgement trigger recognizes from an originating server. In the preferred embodiment, this process allows a user to select which commercials that they want to view.

It is a self running application that is also updated by a “individual” user who updates the software, which includes logic that make digital acknowledgement trigger “work and activate”, for centralized development, uniformity and would guarantee the integrity of those same files that are stored and shared on the above mentioned servers and networks.

The most prevalent use of peer-to-peer networking is the trading of music, video and content that is intellectually protected all across the Internet. Systems such as Napster have been developed specifically to foster that purpose. However, the invention is not limited in its capabilities to publish particular types of content, enabling users to publish and share any form of content across the network. This includes “live” content feeds. As will be described below, publishing and retrieval of content across the network is accomplished anonymously. Further, conventional systems suffer from inherent disadvantages, some of which were described above, which the present invention purports to solve.

The invention provides a stable, reliable and scalable system for publishing downloading and collecting royalties for their content's “proper use.” Subscribers contribute resources to the network community by performing one or more services (for instance, storing blocks of data or hosting a tracking or relay service), in return for some type of payment such as viewing an advertisement, that they can use to browse and download available content within the network, or otherwise transact with the network.

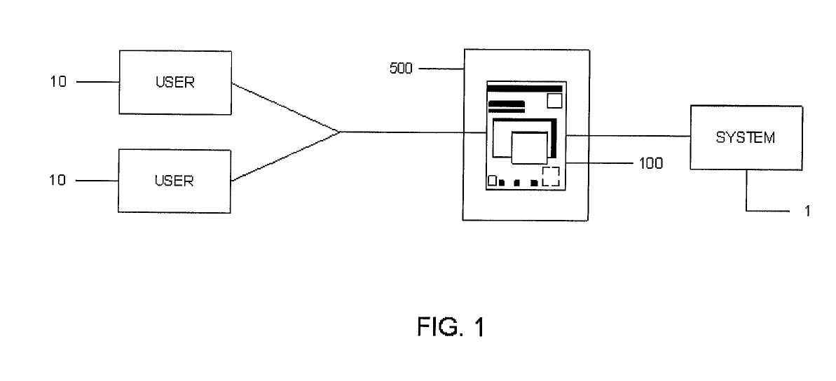

FIG. 1 illustrates a functional diagram of a computer network for World Wide Web 500 access to the system 1 from a plurality of Users 10 to the System Web Site 100. Accessing the System Web Site 100 can be accomplished directly through a communication means such as a local Internet Service Provider, often referred to as ISPs, or through an on-line service provider like CompuServe, Prodigy, American Online, etc.

The Users 10 contact the System Web site 100 using an informational processing system capable of running an HTML compliant Web browser such as Microsoft's Internet Explorer, Netscape Navigator, Lynx and Mosaic. A typical system that is used is a personal computer with an operating system such as Windows 95, 98 or ME or Linus, running a Web browser. The exact hardware configuration of computer used by the Users 10, the brand of operating system or the brand of Web browser configuration is unimportant to understand this present invention. Those skilled in the art can conclude that any compatible Web browser is within the true spirit of this invention and the scope of the claims.

In a traditional client-server distributed system, application software is usually split between server tasks and client tasks. A client system typically transmits a request to the server and the server responds accordingly. A part of the system that prepares or exchanges information on behalf of a server or a client is known as an agent. In a peer-to-peer system, each agent performs both server and client roles.

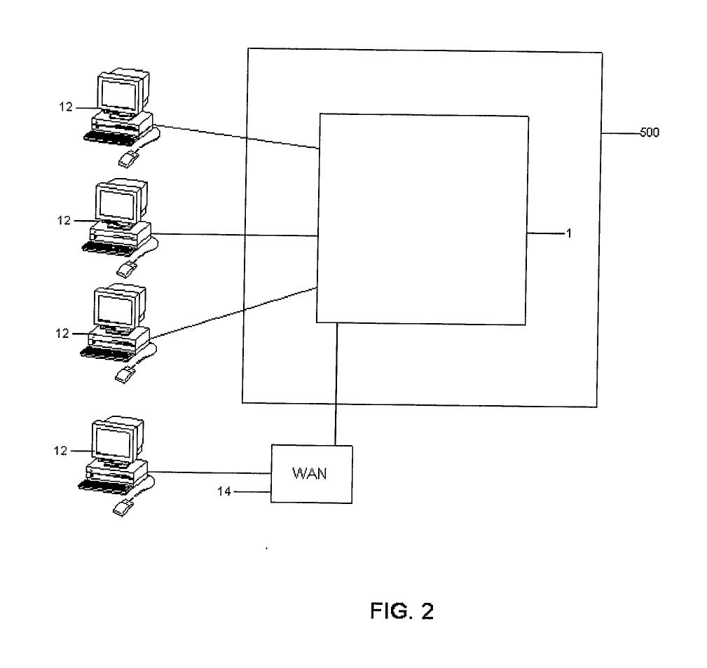

FIG. 2 is a diagram illustrating a peer-to-peer network in accordance with the invention. The system 1 may include a plurality of clients 12 connected in a peer-to-peer fashion across a wide area network (WAN) 14, such as the Internet, or more particularly, the World Wide Web. The User 10 may contain one or more pieces of software code 16 (agents) that may be stored on these machines and may be executed by a respective microprocessor 18 in order to operate as the invention. The Internet 500 permits the machines 12, when accessed by other machines 12 in the network 14, to communicate with each other in order to serve or host various requests or operations and to otherwise interact with each other.

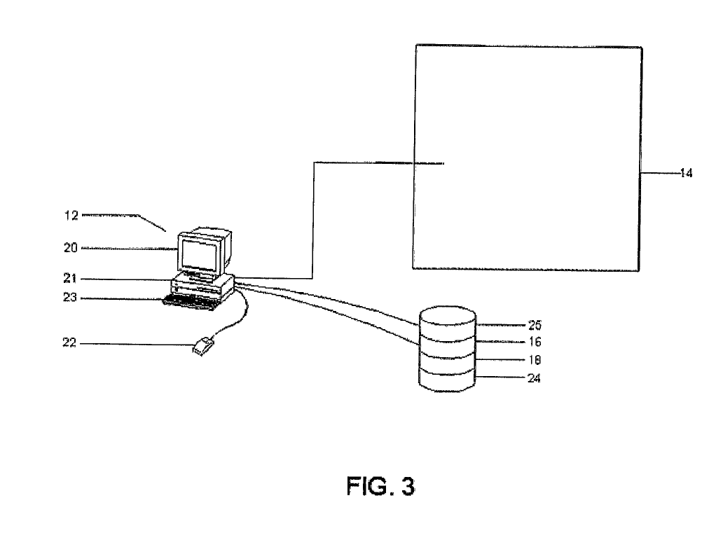

FIG. 3 is a diagram illustrative a representative client computer system 12 that is connected to the network 14 as shown in FIG. 2. Representative client computer systems 12 may include a display device 20, a chassis 21, and one or more user input devices, such as a mouse 22 and a keyboard 23. The chassis 21 may house a permanent storage system 24, such as a hard disk drive, optical disk drive, tape drive, or the like, which may store one or more software applications such as a web browser application 25, and one or more agents 16. The client computer system 12 may have a memory 26 resident therein and the software application(s) from the disk 24 may be transferred to the memory 26 to be executed by a CPU 18 in the computer system 12. The browser application 25 may be configured to connect the client computer system 12 with other machines 12 in the network 14 and receive graphical information (i.e., web pages) that may be displayed on the display device 20 to a user. The browser application 25 may also permit the client computer systems 12 to interact with the other machines 12 in order to serve or host requests and operations in accordance with the invention.

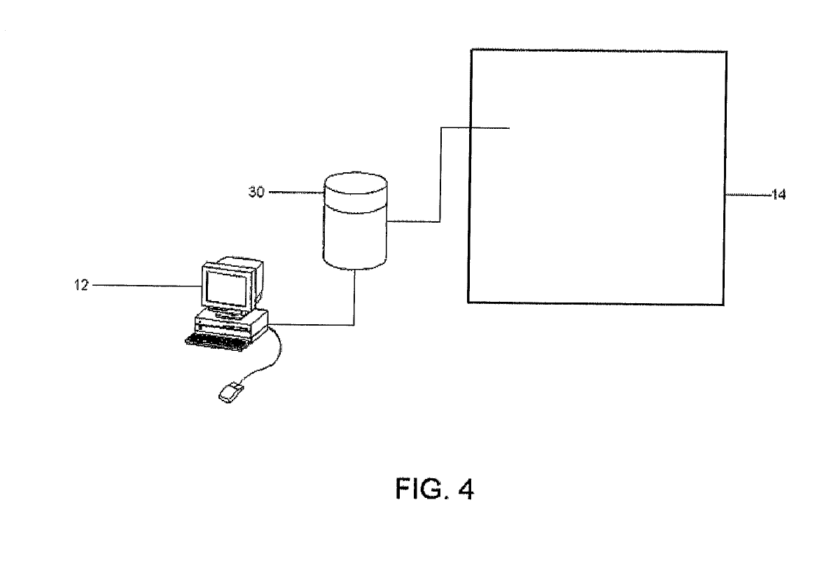

FIG. 4 is a diagram representing software components 16 that may be stored on the client computer systems 12 to enable those systems 12 to utilize and contribute to the network 14 in accordance with the invention. The client computer systems 12 may include a first software module 30 (i.e., a client agent) that is operable to enable these machines 12 to access the network 14 and be capable of consuming system resources provided by other systems 12 connected to the network 14. A user 10 may download and install the client agent 30 from the Internet using techniques that are well known in the art, or may purchase, or otherwise obtain the client agent and directly install the client agent 30 onto the computer system 12.

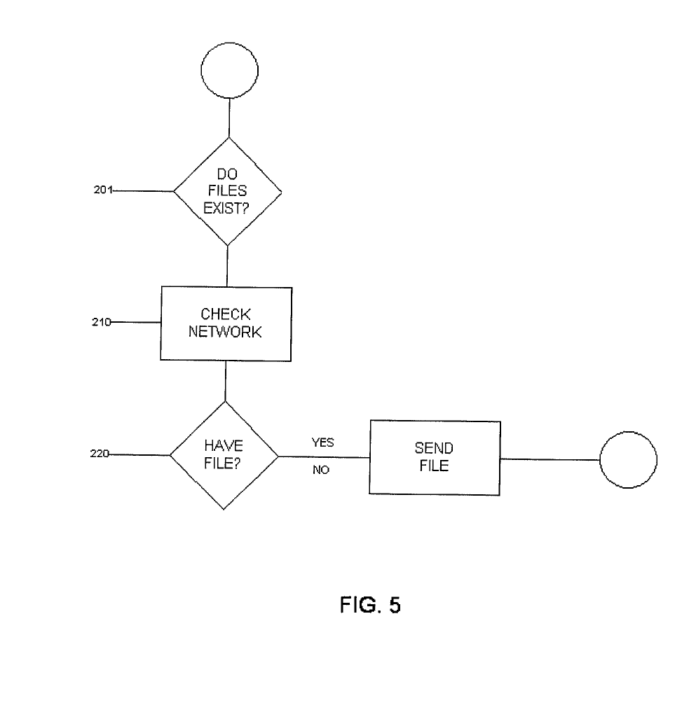

As shown in FIG. 5, in order for the digital acknowledgement trigger and invention to work, users of a p2p audio and video network, for example, would use the software, which would be used by the “end-user” of network to operate the process so it works as such: 1. A user/computer “user” asks a “computer or network related computer or server” if a audio art exits on that particular computer or network related computer or server 201.

2. Every computer or network server or device which is “hooked” up or hooked into that same particular computer or network related computer or server mentioned in node 201 above, responds with a YES or a NO 210.

3. Every computer or network server or device which is “hooked” up or hooked into that same particular computer or network related computer or server mentioned in Node 210 above that answers yes, then hooks up or hooks directly into the user/computer's computer or network related computer or server for download 220.

Each user has a unique Digital Acknowledgement Trigger 125. This trigger is induced by the end user of that particular computer or network related computer or server mentioned in node 210. Each trigger is unique based upon the source IP address of each user and file name requested for download is recognized by the file extension type and with each user's “digital acknowledgement trigger” 125 when activated at the time the Digital File is requested by the user without damaging or manipulating the original file intended for use.

This invention ensures that the owner of a particular file with or without Digital Rights Management embedded file is paid royalty for the “proper use” of the product. i.e.: A Digital Rights Management embedded file may expire or destroy itself after 5 uses or just one. This invention allows for owners of Digital Rights Management enduced files to be paid royalties for files used over a computer network or a P2P network.

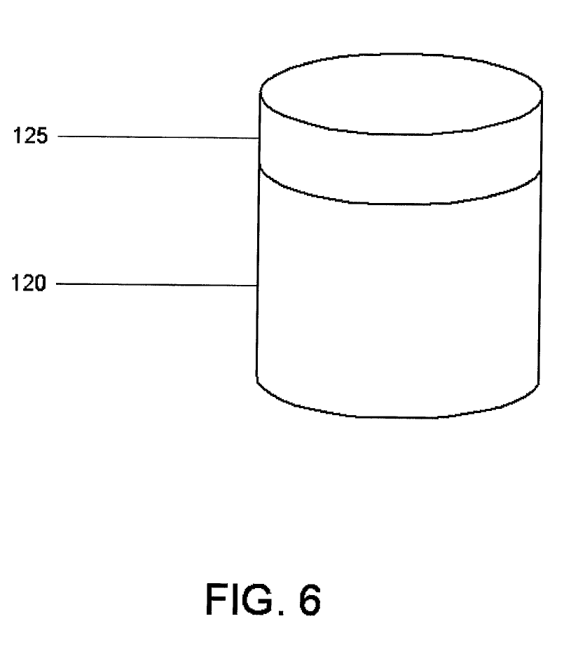

FIG. 6 shows the digital acknowledgement trigger 125 being activated just before the file is allowed to reach the end users hard drive. The digital acknowledgement trigger 125 “activity reporting and process” is unique for each user and for each file played. Some files may have a higher royalty rate than others as pre determined by the owner of a particular file.

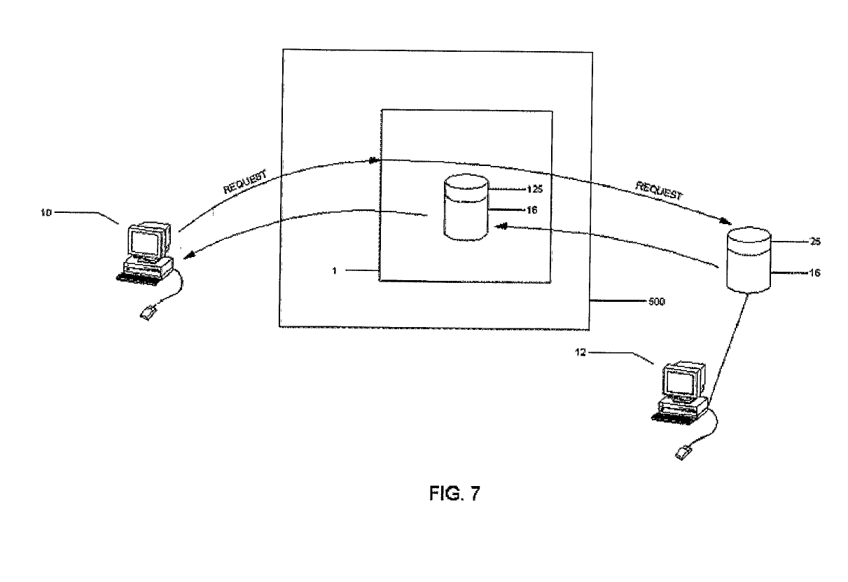

FIG. 7 shows the process in which the requested file is transferred. The user 10 makes the request to the system 1. The system 1 then makes a request to the other clients 12. If one of the other clients 12 has the requested file, the file 120 is uploaded to the system 1. The user's digital acknowledgement trigger 125 acknowledges the “request” the user has made to upload or download the file 120. The file 120 is then downloaded from the system 1 to the User 10 and the digital acknowledgement acknowledges the users preferences for commercials, and allows the user to select their commercial request and when then the trigger acknowledges the user has played the advertisement the trigger registers a royalty back to a computing system and the trigger allows the file to be download or upload to or from the users system to a secure area on their server.

Operation

Businesses and corporations will use license software which includes the logic that includes the digital acknowledgement trigger 125, this produces the protected process which ensures that one's P2P or “file sharing” business can enter “commercial” status legally while keeping all parties that have a “vested” interest in a particular file “happy.” Businesses and corporations will use software to embed their users with a unique digital acknowledgement trigger 125 in order to track all respective “to be downloaded or shared” files that are shared within one's respective business or consumer communities that are “open” for access and download.

When the user/computer 10 download is complete, and the file now also originates from the computer or network related computer or servers to which the download was delivered, that user opens or uses the file for the software trigger, or digital acknowledgement trigger 125 activated the process for which the invention is invented.

When the user/computer 10 the “file” 120, the trigger process 1 then does: a—Provides the originating file owner, or named entity to be determined, the following information: id's the user/computer 10 where the file is opened, the date, and how often the file is transferred, exchanged, emailed, has others download the file from that users secure part of their hard drive for it trigger.

Then the process sends and or routes information and or payments directly to the parties involved in a P2P or file sharing networking environment. These parties are typically, the intellectual property owner, the licensee who licenses the intellectual properties, and the networks, internet service providers or presence providers that host or provide for the actual originating file download that is shared by end users of that particular file or provides Users 10 for these exchanges.

1. Thus, software induced process is capable of sending software trigger to an originating platform, or “digital acknowledgement “125”

a—before the files are requested for download and allows the user to select an audio or video commercial for the user's royalty accountability based on the user/computer's preferences.

b—After preferences are acknowledged, the software trigger, or “digital acknowledgement trigger 125” allows for a process that in which commercial advertisement can also be assigned before “delivery or download” based on the users “preferences” that will open before the file is downloaded by the user/computer 10 and serves it's purpose. In this case, the end user of the computer or network related computer would have to installed or download a the software trigger, or “digital acknowledgement trigger 125” equipped program, order for the User 10 to pay for “proper use” using the process for which the invention is made for then and only then after the user is accounted for a royalty the user then would listen or read or view an audio or video compressed commercial before the actual file is downloaded and “breeched”, and the software trigger, or “digital acknowledgement trigger 125” activates and reports. This process essentially works for all downloaded and shared Internet based, network based, and computer based multi-media materials or other “content.” The software trigger or “digital acknowledgement trigger 125” then reports the information back to the originating licensee or owner of the file that is used for royalty payment.

c—This allows for property owners and parties with “interest” a particular file, as viewed above, to approach advertisers or partners for commercialism of the P2P networking or file sharing “process”. The software trigger, or “digital acknowledgement triggers smart technology” allows the commercial to be played only once or many times, or changed completely or on schedule—monthly, weekly) allows for The software trigger, or “digital acknowledgement trigger 120” to re-activate itself when another user downloads and/or requests another file. This process can also include the capability to allow the users 10 to choose which advertisements or types of advertisement that they wish to view based on their preferences which the digital acknowledgement trigger 125 recognizes. d—invention allows for “file owners” or entities that share files to program each unique digital acknowledgement trigger 125 to acknowledge or allow: 1—play or send out message to end-user 2—integrate or remove commercials images/data or other means of based on current events or certain campaign times of the year. i.e.: Christmas

3—reset its commercial programming after a specified period of time 4—change product advertisement/properties in and/or the need for additional programming for the file regulator will be able to install and remove advertisement using computer generated software that automates this process. 5—“file owners” or entities that share files to program the files to report royalties for advertising fees, report number of downloads vs. actual opening of files, reports overall usage of a file's life span, as viewed above. When the user of the computer or network related computer or servers is complete, if they decide to send that file to another entity or computer network, person or entity or computer or network server, The software trigger, or “digital acknowledgement trigger 125” will, again, re-activate itself again when the file is requested and operates steps #1 through #2, as seen above, and consequently this step, #3.

In summary, the software trigger, or “digital acknowledgement trigger 125” process invention allows for computers, and programs to work together to provide steps needed for this “process” of tracking and regulating “process” of file sharing over computer devices, server, private networks. Therefore this invention, the software trigger, or “digital acknowledgement trigger” provides the following solutions: 1. Costly and timely legal disputes that are taking place in a “un-regulated” “process” where computer files are shared between networks, other computers and people. Infringements will now be limited in P2P and “file sharing” environments, due to the tracking and royalty payment process induced by the invention and protecting of Intellectual properties or owned files. The protected process helps protect companies that own and deliver P2P type of networks to the commercial and consumer markets worldwide.

2. Allows for all parties that have an owned or licensed interest in the particular “file shared” to track all end user destinations for determination of royalty payments, business development or however the entity that owns “the shared file” deems fit. “PARTIES” that have an interest in the “shared file” include, but not limited to: a—The originating server where “the file shared”. In this case, the owner of the server, computer or network . . . . b—The person, network, computer device, server requesting the “shared file”. . . . c—The person, network, computer device, server opening the “shared file”. . . . d—The person, network, computer device or server that shares the opened “shared file”. . . .

3. Allows for the continuation of “free downloads and legal use of the content” by consumers.

4. Control's the overall distribution of files between computers, servers, network servers and unknown entities.

5. Provides for legal and market commercialization structure and demeanor or methodology for P2P and “file sharing” networks.

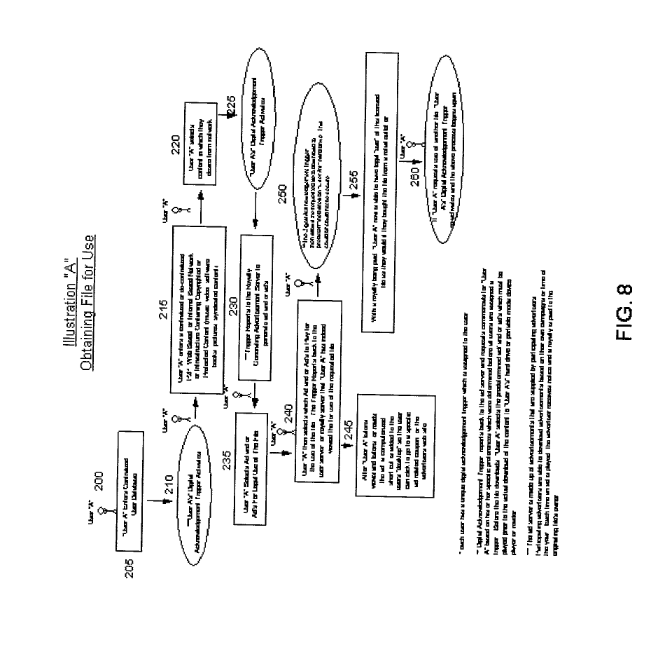

FIG. 8 shows the process that a User 10 obtains a file for use their the User Digital Acknowledgement Trigger process. User A 200 starts by entering a Centralized database of the system 1 in step 205. The system 1 activates a digital acknowledgement trigger 125 for User A 200 in step 210. In step 215, User A 200 enters into a network the contains the desired content. The User A 200 selects the content 220. User A”s digital acknowledgement trigger 125 is activated in step 225. The digital acknowledgement trigger 125 reports to the required royalty server for potential advertisement or royalties associated with the content 230. User A 200 makes a select of the desired advertisement if there is a choice 235. The system 1 is notified of the advertisement that User A 200 has chosen to hear and/or view 240. After the advertisement is listened to or viewed the system 1 may add either a digital coupon or a hot button to the advertiser”s website 245. In step 250, the content is allowed to be downloaded by User A 200. In step 255, User A 200 could use the content. If User A wants to download or view another file or content User A 200 repeats the process 260.

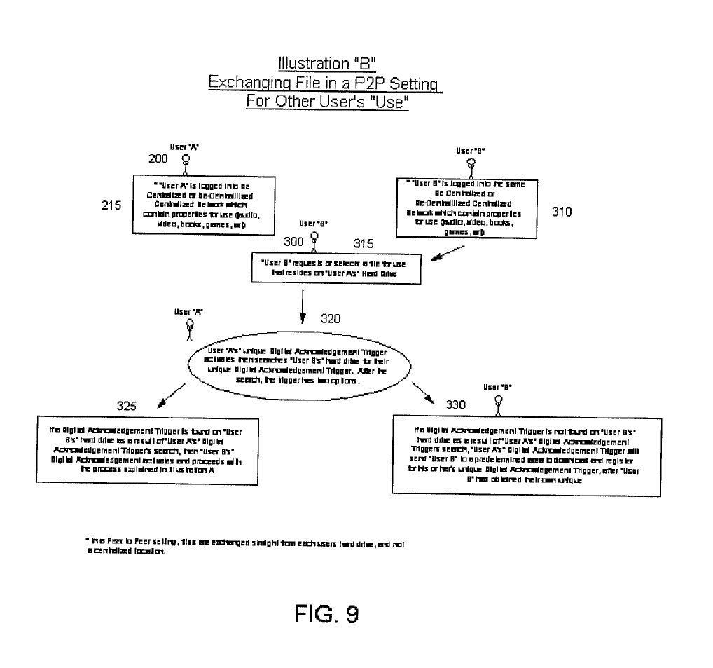

FIG. 9 shows how the exchanging of files between users 10 works in a User Digital Acknowledgement Process. In step 215, User A 200 enters into a network to look for the desired content. In step 310, User B 300 enters into a network to look for the desired content. User B 300 selects the content from User A”s 200 hard drive 24. In step 320, User A”s 200 unique digital acknowledgement trigger 125 searches User B”s 300 hard drive 24 for User B”s 300 unique digital acknowledgement trigger 125. In step 325, if a digital acknowledgement trigger 125 is found on User B”s 300 hard drive 24 the procedure for obtaining file given in FIG. 7 is followed by User B 300. In step 330, if a digital acknowledgement trigger 125 is not found on User B”s 300, the system 1 will send User B 300 to a website 100 in which User B can receive their own digital acknowledgement trigger 125.

Alternative Embodiments With the emerging markets of wireless, Interactive TV, etc. . . . There also new emerging network platforms that also can be developed around a P2P or file sharing network oriented community. The file sharing networks mentioned or P2P file sharing network infrastructure platforms are currently being designed for the wireless internet, interactive television, satellite dish communications, television, personal recording devices, and more that are yet to emerge.

The current invention and process works seamlessly, with any file opener, browser, media player that is in existence within these emerging industries. The digital acknowledgement trigger 125 works with, and is not limited to any of the below file sharing industries: 1—Audio Multi-Media File Sharing,(includes mp3, wavdigital art) 2—Video Multi-Media File Sharing 3—Digital Audio File Sharing 4—Digital Video File Sharing 5—Wireless file streaming, sharing, transferring etc. 6—Digital Art, Protected Arts, works.

7—Gaming Art Sharing.

An entity that regulates, originates or owns a P2P or file sharing network infrastructure allows public access to files on their respective servers and or web portals, via the Internet. The public/consumer then:—Be provided free access to the digital audioart via “free” and or “paid” membership or subscription.

Once registered not requiring registration, the end user and or consumer downloads and or plays files which originate from that respective entities business model.

The respective entities then can then monitor downloads, statistics, trends, demographics etc.

The initiates software trigger, or “digital acknowledgement trigger 125” which is stored and set-up within a user”s unique hard drive. Each corporation or company will have its own unique “brand” of the software trigger, or “digital acknowledgement trigger 125” embedded in their user”s 10 hard drive 24. When the public user downloads the file or data, the data is sent to all parties with “interest” for processing Each users 10 “digital acknowledgement trigger 125”, is sent to the servers which originate the “file download or transfer”, an advertising company is matched to the users pre selected preferences before a unique digital acknowledgement trigger is assigned to the user. The invention induced trigger, or “digital acknowledgement trigger 125 will then determine which advertisers, if any, have partnered with specific digital audio, video or data file being sent to user. The invention induced the software trigger, or “digital acknowledgement trigger 125” will send the commercials out based on the preferences and information the user 10 selected before they were provided their “unique” digital acknowledgement trigger 125 received or based on the selection of the User 10.

For example:—Specific advertisers are partnered with specific corporations MP3”s—Example Sony Music owns Madonna and the partnership agreement is with Pepsi Cola—The end user will receive the Madonna MP3 and only the Pepsi commercial.

The end users” MP3 or video player or file reader will assemble the “digital audio or video” file and the Commercial together. Once the commercial is played, the software trigger, or “digital acknowledgement trigger” can be or removed by the user. The user when the royalty is paid from the invention process then is allowed “proper use.” The end user will only hear the commercial once per download of that specific song or video is played.

If the song or content is shared or transferred to another computer the software trigger, or “digital acknowledgement trigger 125” will be re-initiated, and the process will repeat.

The advertiser and file owner can decide if the commercials are: 1. played once, always played, “infinite loop”, or without any option to remove the commercial 2. the software trigger, or “digital acknowledgement trigger 125” is rendered “inactive” after the file is reaches the users specified area of their hard drive 24. This area can be secured or unsecured. The trigger 125 will be re-activated when files are shared for sent to another user. The trigger 125 will then determine by searching the recipients hard drive for another digital acknowledgement trigger to activate the recipients trigger to begin the process again.

3 .allows for the trigger 125 to automatically acknowledge when an advertiser or a file content owner changes or expires after a certain timeframe as from the ad sever. This will be an automatic or predetermined “reset” after a predetermined time (monthly, weekly etc) which allows for the users software trigger, or “digital acknowledgement trigger 125” to be changed to another product or advertiser.

4 .updated to a new commercial from same advertiser Initially, the end user has options to play/use the MP3/data in an enabled web browser or content player/viewer advertisers set rates, for example, are based on:—A blanket license—per downloaded file—per artist to partner with The invention produced digital acknowledgement trigger analyses the data to determines the royalties owed and forwards payment to the respective owners, or organizations responsible. (ASCAP, SOCAN, RIAA etc.) The solution in summary: • Solves Internet Music Industry Copyright Infringements• Prevent under aged persons from accessing protected media (adult lyrical content in songs and video) • Timed released to other geographies (to curb unauthorized foreign release) until the “proper launch date” in a specific geography. Allowing for multi lingual platforms to be made to facilitate this invention the various languages around the world • Controlled distribution of MP3”s • User Statistics • Royalty Tracking and Payment • Free LEGAL MP3”s to the public • Promote the file sharing and P2P because it is legal.

Conclusion The previously described version of the present invention has many advantages. The current invention is a method for Internet based or peer-to-peer file transfers that is secure, quick, profitable, and legal. The intent is to develop a better method for searching the Internet for specific information from a number of web sites that is accurate, quick, inexpensive, and easy to use, showing there is still room for improvement within the art of paying royalties to content owners for “proper use.”

The digital acknowledgement trigger enhanced process solves the following problems that currently exist with P2P and file sharing networks: • Entities are Unable to track and pay royalties for “proper use” of content/file downloads • Entities are Unable to protect intellectual downloads and usage. • Entities are Unable to determine the amount of downloads and or time the file has been “shared” and paid for • Entities are Unable to commercialize, profit from computer networks, like P2P, which encourage and allow for file sharing that does not produce royalties for user “proper use.”

Although the present invention has been described in considerable detail with reference to certain preferred versions thereof, other versions are possible. For example, it could be used with non-peer-to-peer processing different file structures, different formatting or platforms. Therefore, the point and scope of the appended claims should not be limited to the description of the preferred versions contained herein.

That which is claimed is:

1. A distributed system for publishing and retrieving content in a network, comprising: a plurality of computer systems connected together in a peer-to-peer fashion; one or more software applications associated with the computer systems for allowing the computer systems to publish and retrieve content from the network by initiating peer-to-peer interactions across the network using a user based digital trigger acknowledgement.

2. The distributed system of claim 1, wherein the computer systems have characterized network resources that can be contributed to the network in return for viewing an advertisement.

3. The distributed system of claim 1, wherein the network resources include any of disk space, bandwidth, and CPU processing cycles.

4. The distributed system of claim 1, wherein the interactions are performed by the client-server applications.

5. The system of claim 1, wherein each interaction across the network involves a transaction cost.

6. The distributed system of claim 1, wherein the content can be retrieved in return for viewing an advertisement.

7. The distributed system of claim 1, wherein the content can be retrieved in return for an advertisement being viewed when using the content and the user can select the advertisement from a plurality of advertisements

8. The distributed system of claim 1, wherein the content can be retrieved in return for an advertisement being viewed while retrieving the content from the network.

9. The distributed system of claim 1, wherein the parts of the network may be connected through one or more of the following types of connections.

10. The distributed system of claim 1, wherein the system keeps track of the content.

11. A distributed system for publishing and retrieving content in a network, comprising: a plurality of computer systems connected together in a peer-to-peer fashion; one or more software applications associated with the computer systems for allowing the computer systems to publish and retrieve content from the network by initiating peer-to-peer interactions across the network using a user based digital trigger acknowledgement.

12. The distributed system of claim 11, wherein the computer systems have characterized network resources that can be contributed to the network in return for viewing an advertisement.

13. The distributed system of claim 11, wherein the network resources include any of disk space, bandwidth, and CPU processing cycles.

14. The distributed system of claim 11, wherein the interactions are performed by the client-server applications.

15. The system of claim 11, wherein each interaction across the network involves a transaction cost.

16. The distributed system of claim 11, wherein the content can be retrieved in return for viewing an advertisement.

17. The distributed system of claim 1, wherein the content can be retrieved in return for an advertisement being viewed when using the content and the user can select the advertisement from a plurality of advertisements

18. The distributed system of claim 11, wherein the content can be retrieved in return for an advertisement being viewed while retrieving the content from the network.

19. The distributed system of claim 11, wherein the parts of the network may connected through a wireless connection.

20. The distributed system of claim 11, wherein the system keeps track of the content.
